(19) United States
(12) Patent Application Publication
(10) Pub. No.: US 2023/0245097 A1
(43) Pub. Date: Aug. 3, 2023

(54) PRESSURIZED FLUID DISPENSER

(71) Applicant: Dionysus, LLC, Yukin, OK (US)

(72) Inventors: Caleb Briggs, Yukon, OK (US); Grant Bisel, Oklahoma City, OK (US); Jason Swanson, Shattuck, OK (US)

(21) Appl. No.: 18/296,808

(22) Filed: Apr. 6, 2023

Related U.S. Application Data
(63) Continuation of application No. 16/771,093, filed on Jun. 9, 2020, now abandoned.
(60) Provisional application No. 62/835,181, filed on Apr. 17, 2019.

(51) Int. Cl. G06Q 20/32; G06V 40/16; G06Q 20/18; G06Q 20/22

(52) U.S. Cl. CPC G06Q 20/3274; G06V 40/172; G06Q 20/18; G06Q 20/227; G06Q 20/3224; G06Q 20/3278; G06Q 20/3263; G07F 13/00

(57) ABSTRACT

Systems and methods for controlling fluid distribution including at least one kiosk in communication with at least one user device, the user device having a second set of instructions that, when executed, cause the user device to accept input of user information and store the user information in a second database; capture an image of a form of identification of the user; identify text in the image of the identification and match that text with the user information in the second database; generate a code for communication to the at least one kiosk; upon receiving the code, a first set of instructions cause the kiosk to accept input from the user indicative of a selection of a type and a number of units of fluid; and dispense the type and number of units of fluid and store the type and number of units of fluid associated with the user.

### INCORPORATION BY REFERENCE

This application is a continuation of U.S. Ser. No. 16/771,093, filed Jun. 9, 2020; now pending; which is a US national stage application filed under 35 USC § 371 of International Application No. of PCT/US2020/28084, filed Apr. 14, 2020, now abandoned; which claims priority to U.S. Provisional Application No. 62/835,181 filed Apr. 17, 2019. The entire contents of the above-referenced patent applications are hereby expressly incorporated herein by reference.

### BACKGROUND

Many businesses, such as restaurants and bars, in the United States and throughout the world distribute large volumes of pressurized fluid beverages such as soft drinks and beer. In such establishments, these drinks are typically delivered by a bartender or server. However, there can sometimes be a substantial wait before a beverage is delivered to a consumer because there are far more consumers than bartenders or servers at a given location.

Some establishments have resorted to self-serve dispensers for products such as soft drinks. However, this does not allow the business to determine the total amount of beverages dispensed to each consumer so that consumers can be charged for each drink.

In addition, beverages that are subject to age restrictions, such as beverages containing alcohol require verification of the age of each consumer by law. If this age verification is not properly done, businesses may be subjected to heavy fines or closure.

Therefore, a need exists for a pressurized fluid dispenser that solves the aforementioned problems while still providing the convenience of on-demand purchasing. It is to such an improved system that the presently disclosed inventive concepts are directed.

### BRIEF DESCRIPTION OF THE SEVERAL VIEWS OF THE DRAWINGS

To assist those of ordinary skill in the relevant art in making and using the subject matter hereof, reference is made to the appended drawings, which are not intended to be drawn to scale, and in which like reference numerals are intended to refer to similar elements for consistency. For purposes of clarity, not every component may be labeled in every drawing.

FIG. 1 is a diagrammatic view of hardware forming an exemplary embodiment of a system for distributing a pressurized fluid constructed in accordance with the present disclosure.

FIG. 2 is a diagrammatic view of an exemplary user device for use in the system for distributing a pressurized fluid illustrated in FIG. 1.

FIG. 3 is a diagrammatic view of an exemplary host system for use in the system for distributing a pressurized fluid illustrated in FIG. 1.

FIG. 4 is a diagrammatic view of an exemplary kiosk terminal for use in the system for distributing pressurized fluid illustrated in FIG. 1.

FIG. 5 illustrates an exemplary begin page of a user interface displayed on a kiosk terminal constructed in accordance with the present disclosure.

FIG. 6 illustrates an exemplary scan page of a user interface displayed on a kiosk terminal constructed in accordance with the present disclosure.

FIG. 7 illustrates an exemplary product selection page of a user interface displayed on a kiosk terminal constructed in accordance with the present disclosure.

FIG. 8 illustrates an exemplary dispense page of a user interface displayed on a kiosk terminal constructed in accordance with the present disclosure.

FIG. 9 illustrates an exemplary password page of a user interface displayed on a kiosk terminal constructed in accordance with the present disclosure.

FIG. 10 illustrates an exemplary settings page of a user interface displayed on a kiosk terminal constructed in accordance with the present disclosure.

FIG. 11 illustrates an exemplary kiosk tenant page of a user interface displayed on a kiosk terminal constructed in accordance with the present disclosure.

FIG. 12 illustrates an exemplary kiosk location page of a user interface displayed on a kiosk terminal constructed in accordance with the present disclosure.

FIG. 13 illustrates an exemplary kiosk setup page of a user interface displayed on a kiosk terminal constructed in accordance with the present disclosure.

FIG. 14 illustrates an exemplary sign in page of a user interface displayed on a user device constructed in accordance with the present disclosure.

FIG. 15 illustrates an exemplary sign-up page of a user interface displayed on a user device constructed in accordance with the present disclosure.

FIG. 16 illustrates an exemplary alternate sign in page of a user interface displayed on a user device constructed in accordance with the present disclosure.

FIG. 17 illustrates an exemplary balance page of a user interface displayed on a user device constructed in accordance with the present disclosure.

FIG. 18 illustrates an exemplary credit card page of a user interface displayed on a user device constructed in accordance with the present disclosure.

FIG. 19 illustrates an exemplary wallet page of a user interface displayed on a user device constructed in accordance with the present disclosure.

FIG. 20 illustrates an exemplary code page of a user interface displayed on a user device constructed in accordance with the present disclosure.

FIG. 21 illustrates an exemplary recent transactions page of a user interface displayed on a user device constructed in accordance with the present disclosure.

FIG. 22 illustrates an exemplary identification page of a user interface displayed on a user device constructed in accordance with the present disclosure.

FIG. 23 illustrates an exemplary increase balance page of a user interface displayed on a user device constructed in accordance with the present disclosure.

FIG. 24 illustrates an exemplary dashboard of a tenant portal displayed on an external system constructed in accordance with the present disclosure.

FIG. 25 illustrates an exemplary items page of a tenant portal displayed on an external system constructed in accordance with the present disclosure.

FIG. 26 illustrates an exemplary add item page of a tenant portal displayed on an external system constructed in accordance with the present disclosure.

FIG. 27 illustrates an exemplary kiosks page of a tenant portal displayed on an external system constructed in accordance with the present disclosure.

FIG. 28 illustrates an exemplary add kiosks page of a tenant portal displayed on an external system constructed in accordance with the present disclosure.

FIG. 29 illustrates an exemplary locations page of a tenant portal displayed on an external system constructed in accordance with the present disclosure.

FIG. 30 illustrates an exemplary edit location page of a tenant portal displayed on an external system constructed in accordance with the present disclosure.

FIG. 31 illustrates an exemplary purchase information page of a tenant portal displayed on an external system constructed in accordance with the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The systems and methods as described in the present disclosure are capable of other embodiments or of being practiced or carried out in various ways. Also, it is to be understood that the phraseology and terminology employed herein is for purposes of description, and should not be regarded as limiting.

The following detailed description refers to the accompanying drawings. The same reference numbers in different drawings may identify the same or similar elements.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements, but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, any reference to “one embodiment,” “an embodiment,” “some embodiments,” “one example,” “for example,” or “an example” means that a particular element, feature, structure or characteristic described in connection with the embodiment is included in at least one embodiment. The appearance of the phrase “in some embodiments” or “one example” in various places in the specification is not necessarily all referring to the same embodiment, for example.

Circuitry, as used herein, may be analog and/or digital components, or one or more suitably programmed processors (e.g., microprocessors) and associated hardware and software, or hardwired logic. Also, “components” may perform one or more functions. The term “component” may include hardware, such as a processor (e.g., microprocessor), a combination of hardware and software, and/or the like. Software may include one or more computer executable instructions that when executed by one or more components cause the component to perform a specified function. It should be understood that the algorithms described herein may be stored on one or more non-transitory memory. Exemplary non-transitory memory may include random access memory, read only memory, flash memory, and/or the like. Such non-transitory memory may be electrically based, optically based, and/or the like.

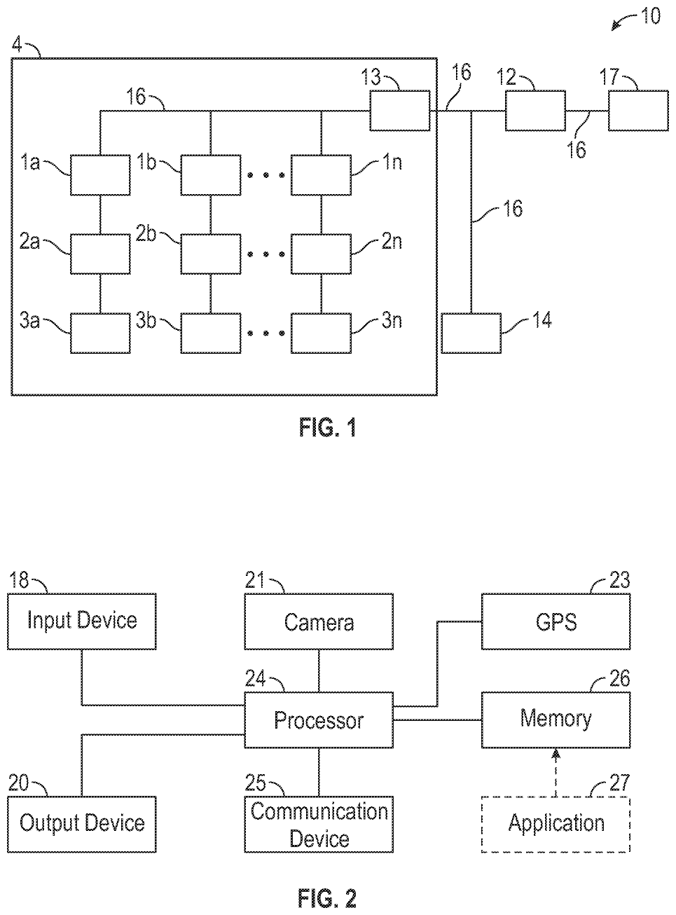

Referring now to the Figures, and in particular to FIG. 1, shown therein is a diagrammatic view of hardware forming an exemplary embodiment of a system 10 for dispensing pressurized fluid constructed in accordance with the present disclosure.

The system 10 is provided with at least one power supply 1a-1n (hereinafter “power supply 1”), at least one solenoid 2a-2n (hereinafter “solenoid 2”), at least one pressurized fluid container 3a-3n (hereinafter “pressurized fluid container 3”), a kiosk 4, at least one host system 12 (hereinafter “host system 12”), an kiosk terminal 13, a plurality of user devices 14 (hereinafter “user device 14”), and a network 16. In some embodiments, the system 10 may include at least one external system 17 (hereinafter “external system 17”) for use by an administrator to add, delete, or modify user information, provide management reporting, or manage information. The system 10 may be a system or systems that are able to embody and/or execute the logic of the processes described herein. Logic embodied in the form of software instructions and/or firmware may be executed on any appropriate hardware. For example, logic embodied in the form of software instructions and/or firmware may be executed on a dedicated system or systems, on a personal computer system, on a distributed processing computer system, and/or the like. In some embodiments, logic may be implemented in a stand-alone environment operating on a single computer system and/or logic may be implemented in a networked environment such as a distributed system using multiple computers and/or processors as depicted in FIG. 1, for example.

The host system 12 of the system 10 may include a single processor or multiple processors working together or independently to perform a task. In some embodiments, the host system 12 may be partially or completely network-based or cloud based. The host system 12 may or may not be located in single physical location. Additionally, multiple host systems 12 may or may not necessarily be located in a single physical location.

In some embodiments, the system 10 may be distributed, and include at least one host system 12 communicating with one or more user device 14 via the network 16. As used herein, the terms “network-based,” “cloud-based,” and any variations thereof, are intended to include the provision of configurable computational resources on demand via interfacing with a computer and/or computer network, with software and/or data at least partially located on a computer and/or computer network.

In some embodiments, the network 16 may be the Internet and/or other network. For example, if the network 16 is the Internet, a primary user interface of the system 10 may be delivered through a series of web pages or private internal web pages of a company or corporation, which may be written in hypertext markup language. It should be noted that the primary user interface of the system 10 may be another type of interface including, but not limited to, a Windows-based application, a tablet-based application, a mobile web interface, and/or the like.

The network 16 may be almost any type of network. For example, in some embodiments, the network 16 may be a version of an Internet network (e.g., exist in a TCP/IP-based network). It is conceivable that in the near future, embodiments within the present disclosure may use more advanced networking technologies.

In some embodiments, the external system 17 may optionally communicate with the host system 12. For example, in one embodiment of the system 10, the external system 17 may supply data transmissions via the network 16 to the host system 12 regarding real-time or substantially real-time events (e.g., user updates, purchases, and/or account updates). Data transmission may be through any type of communication including, but not limited to, speech, visuals, signals, textual, and/or the like. Events may include, for example, data transmissions regarding user messages or updates from a kiosk manager, for example, initiated via the external system 17. It should be noted that the external system 17 may be the same type and construction as the user device 14.

As shown in FIG. 2, the one or more user devices 14 of the system 10 may include, but are not limited to implementation as a cellular telephone, a smart phone, a tablet, a laptop computer, a desktop computer, a network-capable handheld device, a server, a wearable network-capable device, and/or the like.

In some embodiments, the user device 14 may include one or more input devices 18 (hereinafter “input device 18”), one or more output devices 20 (hereinafter “output device 20”), a device locator 23, one or more processors 24 (hereinafter “processor 24”), one or more communication devices 25 (hereinafter “communication device 25”) capable of interfacing with the network 16, one or more non-transitory memory 26 (hereinafter “memory 26”) storing processor executable code and/or software application(s), for example including, a web browser capable of accessing a website and/or communicating information and/or data over a wireless or wired network (e.g., network 16), and/or the like. The memory 26 may also store an application 27 that, when executed by the processor 24 causes the user device 14 to automatically and without user intervention collect information on the user's current location as determined by the device locator 23 to allow the user to access the kiosk terminal 13. In some embodiments, the application 27 is programmed to cause the processor 24 to provide a user input screen (not shown) to the output device 20, and to receive information from the user via the input device 18. Such information can be stored either temporarily and/or permanently in the memory 26 and/or transmitted to the host system 12 via the network 16 using the communication device 25 and may include, for instance, a personal identification number (PIN), a password, a digital access code, or the like.

Embodiments of the system 10 may also be modified to use any user device 14 or future developed devices capable of communicating with the host system 12 via the network 16.

The device locator 23 may be capable of determining the position of the user device 14. For example, implementations of the device locator 23 may include, but are not limited to, a Global Positioning System (GPS) chip, software based device triangulation methods, network-based location methods such as cell tower triangulation or trilateration, the use of known-location wireless local area network (WLAN) access points using the practice known as “wardriving”, a hybrid positioning system combining two or more of the technologies listed above, or any future developed system or method of locating a device such as the user device 14.

The input device 18 may be capable of receiving information input from the user and/or processor 24, and transmitting such information to other components of the user device 14 and/or the network 16. The input device 18 may include, but are not limited to, implementation as a keyboard, touchscreen, mouse, trackball, microphone, fingerprint reader, infrared port, slide-out keyboard, flip-out keyboard, cell phone, PDA, remote control, fax machine, wearable communication device, network interface, combinations thereof, and/or the like, for example.

The output device 20 may be capable of outputting information in a form perceivable by the user and/or processor 24. For example, implementations of the output device 20 may include, but are not limited to, a computer monitor, a screen, a touchscreen, a speaker, a website, a television set, a smart phone, a PDA, a cell phone, a laptop computer, combinations thereof, and the like, for example. It is to be understood that in some exemplary embodiments, the input device 18 and the output device 20 may be implemented as a single device, such as, for example, a touchscreen of a computer, a tablet, or a smartphone. It is to be further understood that as used herein the term user is not limited to a human being, and may comprise, a computer, a server, a website, a processor, a network interface, a human, a user terminal, a virtual computer, combinations thereof, and/or the like, for example.

The host system 12 may be capable of interfacing and/or communicating with the user device 14 and the external system 17 via the network 16. For example, the host system 12 may be configured to interface by exchanging signals (e.g., analog, digital, optical, and/or the like) via one or more ports (e.g., physical ports or virtual ports) using a network protocol, for example. Additionally, each host system 12 may be configured to interface and/or communicate with other host systems 12 directly and/or via the network 16, such as by exchanging signals (e.g., analog, digital, optical, and/or the like) via one or more ports.

The network 16 may permit bi-directional communication of information and/or data between the host system 12, the kiosk terminal 13, the user device 14, and/or the external system 17. The network 16 may interface with the host system 12, the kiosk terminal 13, the user device 14, and/or the external system 17 in a variety of ways. For example, in some embodiments, the network 16 may interface by optical and/or electronic interfaces, and/or may use a plurality of network topographies and/or protocols including, but not limited to, Ethernet, TCP/IP, circuit switched path, combinations thereof, and/or the like. For example, in some embodiments, the network 16 may be implemented as the World Wide Web (or Internet), a local area network (LAN), a wide area network (WAN), a metropolitan network, a 4G network, a 5G network, a satellite network, a radio network, an optical network, a cable network, a public switch telephone network, an Ethernet network, combinations thereof, and the like, for example. Additionally, the network 16 may use a variety of network protocols to permit bi-directional interface and/or communication of data and/or information between the host system 12, the kiosk terminal 13, the user device 14, and/or the external system 17.

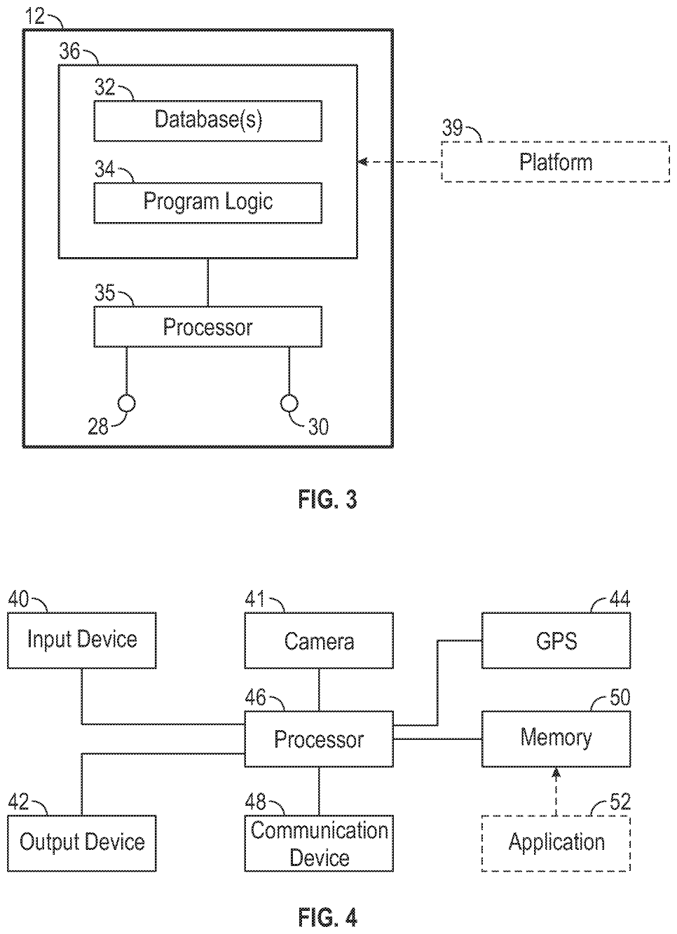

Referring now to FIG. 3, shown therein is a diagrammatic view of an exemplary embodiment of the host system 12. In the illustrated embodiment, the host system 12 is provided with one or more databases 32 (hereinafter “database 32”), program logic 34, and one or more processors 35 (hereinafter “processor 35”). The program logic 34 and the database 32 are stored on non-transitory computer readable storage memory 36 (hereinafter “memory 36”) accessible by the processor 35 of the host system 12. It should be noted that as used herein, program logic 34 is another term for instructions which can be executed by the processor 24 or the processor 35. The database 32 can be a relational database or a non-relational database. Examples of such databases comprise, DB2®, Microsoft® Access, Microsoft® SQL Server, Oracle®, mySQL, PostgreSQL, MongoDB, Apache Cassandra, and the like. It should be understood that these examples have been provided for the purposes of illustration only and should not be construed as limiting the presently disclosed inventive concepts. The database 32 can be centralized or distributed across multiple systems.

In some embodiments, the host system 12 may comprise one or more processors 35 working together, or independently to, execute processor executable code stored on the memory 36. Additionally, each host system 12 may include at least one input device 28 (hereinafter “input device 28”) and at least one output device 30 (hereinafter “output device 30”). Each element of the host system 12 may be partially or completely network-based or cloud-based, and may or may not be located in a single physical location.

The processor 35 may be implemented as a single processor or multiple processors working together, or independently, to execute the program logic 34 as described herein. It is to be understood, that in certain embodiments using more than one processor 35, the processors 35 may be located remotely from one another, located in the same location, or comprising a unitary multi-core processor. The processors 35 may be capable of reading and/or executing processor executable code and/or capable of creating, manipulating, retrieving, altering, and/or storing data structures into the memory 36.

Exemplary embodiments of the processor 35 may be include, but are not limited to, a digital signal processor (DSP), a central processing unit (CPU), a field programmable gate array (FPGA), a microprocessor, a multi-core processor, combinations, thereof, and/or the like, for example. The processor 35 may be capable of communicating with the memory 36 via a path (e.g., data bus). The processor 35 may be capable of communicating with the input device 28 and/or the output device 30.

The processor 35 may be further capable of interfacing and/or communicating with the user device 14, the kiosk terminal, and/or the external system 17 via the network 16. For example, the processor 35 may be capable of communicating via the network 16 by exchanging signals (e.g., analog, digital, optical, and/or the like) via one or more ports (e.g., physical or virtual ports) using a network protocol to provide updated information to the application 27 executed on the user device 14 such as, for instance, access to a kiosk terminal 13 at or near the user's current location.

The memory 36 may be capable of storing processor executable code. Additionally, the memory 36 may be implemented as a conventional non-transitory memory, such as for example, random access memory (RAM), CD-ROM, a hard drive, a solid state drive, a flash drive, a memory card, a DVD-ROM, a disk, an optical drive, combinations thereof, and/or the like, for example.

In some embodiments, the memory 36 may be located in the same physical location as the host system 12, and/or one or more memory 36 may be located remotely from the host system 12. For example, the memory 36 may be located remotely from the host system 12 and communicate with the processor 35 via the network 16. Additionally, when more than one memory 36 is used, a first memory 36 may be located in the same physical location as the processor 35, and additional memory 36 may be located in a location physically remote from the processor 35. Additionally, the memory 36 may be implemented as a “cloud” non-transitory computer readable storage memory (i.e., one or more memory 36 may be partially or completely based on or accessed using the network 16).

The input device 28 of the host system 12 may transmit data to the processor 35 and may be similar to the input device 18 of the user device 14. The input device 28 may be located in the same physical location as the processor 35, or located remotely and/or partially or completely network-based. The output device 30 of the host system 12 may transmit information from the processor 35 to a user, and may be similar to the output device 20 of the user device 14. The output device 30 may be located with the processor 24, or located remotely and/or partially or completely network-based.

The memory 36 may store processor executable code and/or information comprising the database 32 and program logic 34. In some embodiments, the processor executable code may be stored as a data structure, such as the database 32 and/or data table, for example, or in non-data structure format such as in a non-compiled text file.

Referring now to FIG. 4, the kiosk terminal 13 is provided with an input device 40, an output device 42, a device locator 44, a processor 46, a communication device 48, memory 50, and an application 52. The elements of the kiosk terminal 13 are similar to the elements of the user device 14, therefore, the elements of the kiosk terminal 13 will not be described in detail herein. It should be noted however, that the description of the elements of the user device 14 that are the same as the kiosk terminal 13 are herein incorporated by reference.

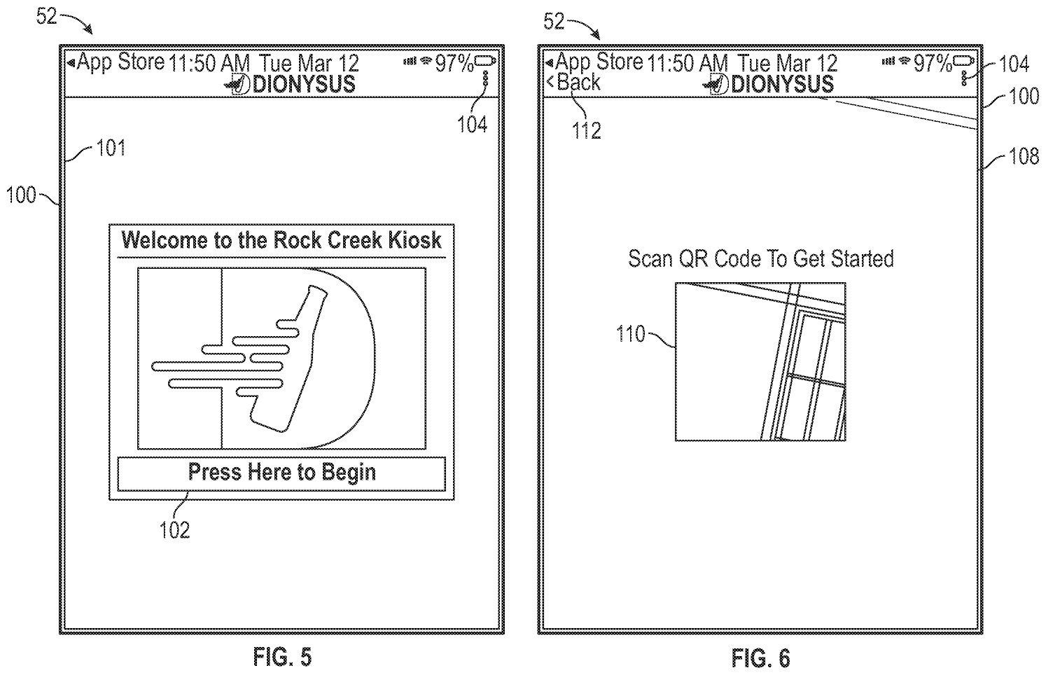

Referring now to FIG. 5, the application 52 running on the kiosk terminal 13 provides a user interface 100 displayed on the output device 42 of the kiosk terminal 13. The user interface 100 may be displayed to a user to initiate a transaction on the kiosk terminal 13. To initiate the transaction, a user may select a begin button 102 on a begin page 101 on the user interface 100. The begin button 102 may be programmed to initiate the transaction on the kiosk terminal 13. The user interface 100 may further be provided with a settings button 104 program to allow a user to interface with the application 52 on the kiosk terminal 13.

Referring now to FIG. 6, when the user selects the begin button 102 the application 52 may be programmed to open a scan page 108. The scan page 108 is provided with a code reader 110, a back button 112, and the settings button 104. The code reader 110 is program to read, for instance, QR codes, barcodes, and the like. The back button 112 may be programmed to help the user navigate through the application 52. For instance, the back button 112 on the scan page 108 would cause the application 52 to return to the begin page 101.

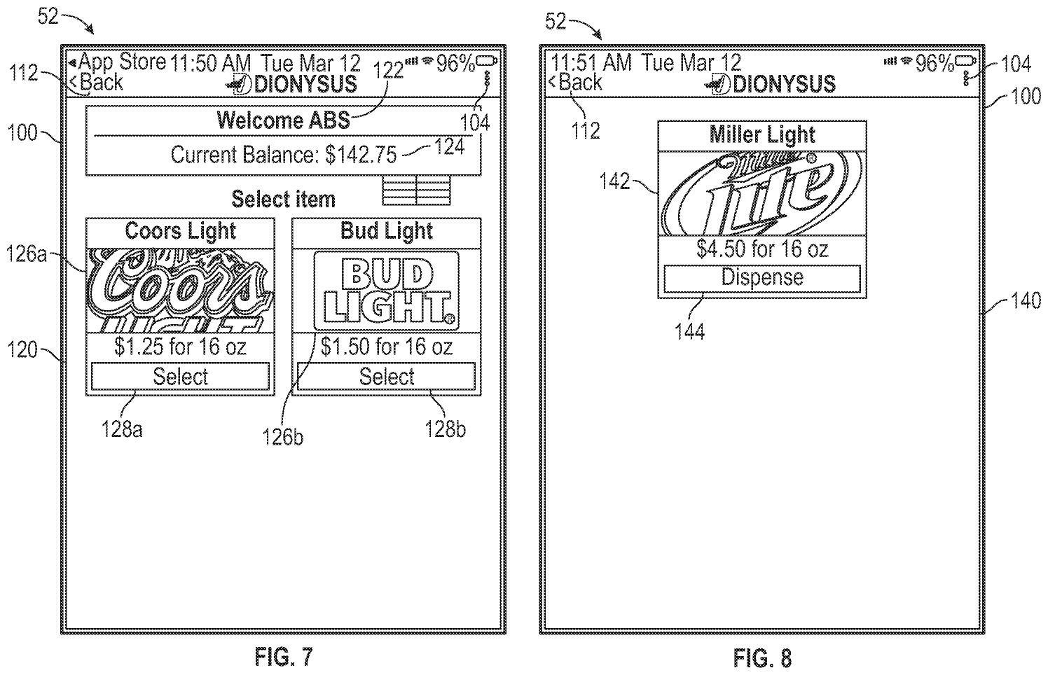

Referring now to FIG. 7, once the user has scanned a QR code, for instance, using the code reader 110 on the scan page 108, the application 52 may be programmed to open a product selection page 120. The product selection page 120 is provided with a user identification section 122, a balance section 124, product identification sections 126a and 126b, and product selection buttons 128a and 128b.

The balance section 124 of the product selection page 120 displays the current balance available to the user for purchases. As will be described further herein, the user may add money to their balance as needed.

The product identification sections 126a and 126b provided information on available products to the user. In the embodiment illustrated in FIG. 7, the available products are Coors light and Bud Light. The product identification sections 126a and 126b further provided cost per unit information to the user. For instance, in the illustrated embodiment Coors light is available for $1.25 for 16 ounces and Bud Light is available for $1.50 for 16 ounces. It should be noted that these products are provided for illustration purposes only and any pressurized fluid can be made available through the system 10 as will this be described further herein.

When the user has chosen a product, the user may make a selection using the product selection buttons 1128a or 128b. Once the user makes selection, the application 52 may be programmed to display a dispense page 140 as illustrated in FIG. 8.

The dispense page 140 may be provided with a selected product section 142 and a dispense button 144. The selected product section 142 allows the user to confirm their selection before dispensing a product. For instance, the selected product section 142 may display product information including a price per unit. To confirm their selection, the user may select the dispense button 144 to dispense the product.

In an exemplary embodiment, when the user selects the dispense button 144 the application 52 causes the power supply 1 to supply power to the solenoid valve 2 causing the purchased number of units of the pressurized fluid in the pressurized fluid container 3 to be dispensed. It should be noted that any number of power supplies 1, solenoid valves 2, and pressurized fluid containers 3 may be present in a kiosk 4. For instance, in a given kiosk 4 each product may be provided with an assigned power supply 1, solenoid valve 2, and pressurized fluid container 3. Thus, when the user selects a product the assigned power supply 1 for that product will supply power to the assigned solenoid valve 2 dispensing the product from the assigned pressurized fluid container 3.

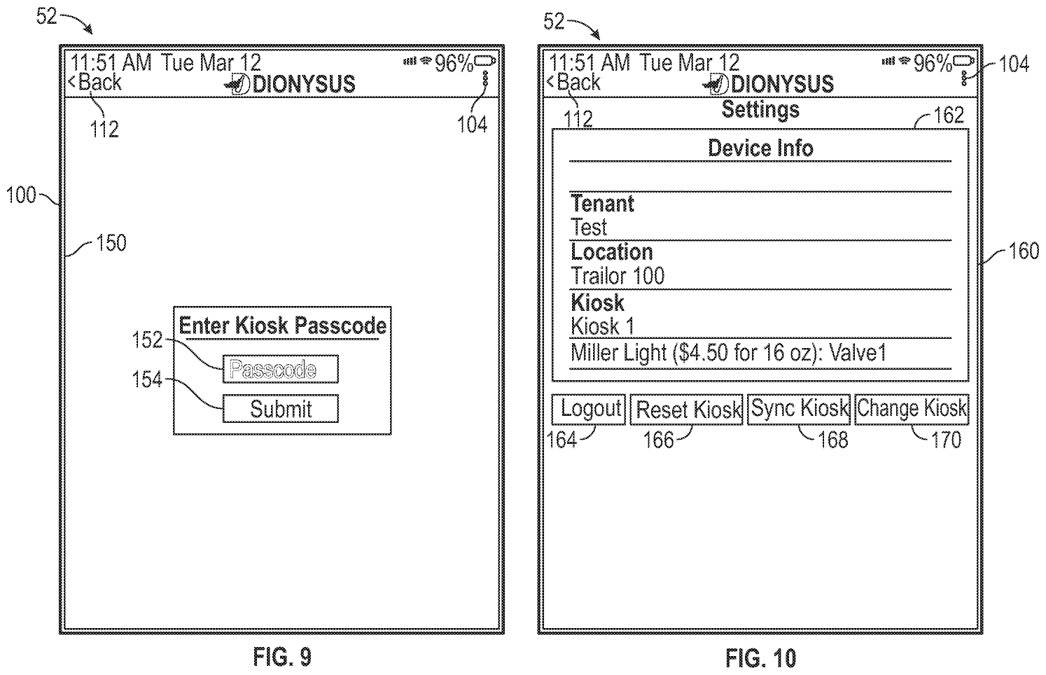

Referring now to FIG. 9, to perform certain tasks on the application 52 of the kiosk terminal 13, the application 52 may be provided with a password page 150. The password page 150 may be provided with a password section 152 and a submit button 154. The password section 152 may be programmed to receive input from the user indicative of a password as is known in the art. Once the user has entered their password the user may select the submit button 154.

If the user enters a recognized password in the password section 152 of the password page 150, the application 52 may be programmed to display a settings page 160 as illustrated in FIG. 10. The settings page may include a device information about the kiosk terminal 13 such as tenant information, location information, kiosk information, and product information in a device info section 162. The settings page 160 may further be provided with a logout button 164, a reset kiosk button 166, a sink kiosk button 168, and a change kiosk button 170.

The logout button 164 of the settings page 160 may be programmed to cause the application 52 to exit from the kiosk management section.

The reset kiosk button 166 may be programmed to cause the application 52 to reset or restart on the kiosk terminal 13. Alternatively, the reset kiosk button 166 may be programmed to cause the kiosk terminal 13 to restart reset or restart.

The sync kiosk button 168 may be programmed to cause the application 52 to connect with the host system 12 to download product information, updates for the application 52, or other necessary information, for instance.

The change kiosk button 170 may be programmed to take the user to a page (not shown) that allows the user to change the name, location, or other information about the kiosk terminal 13.

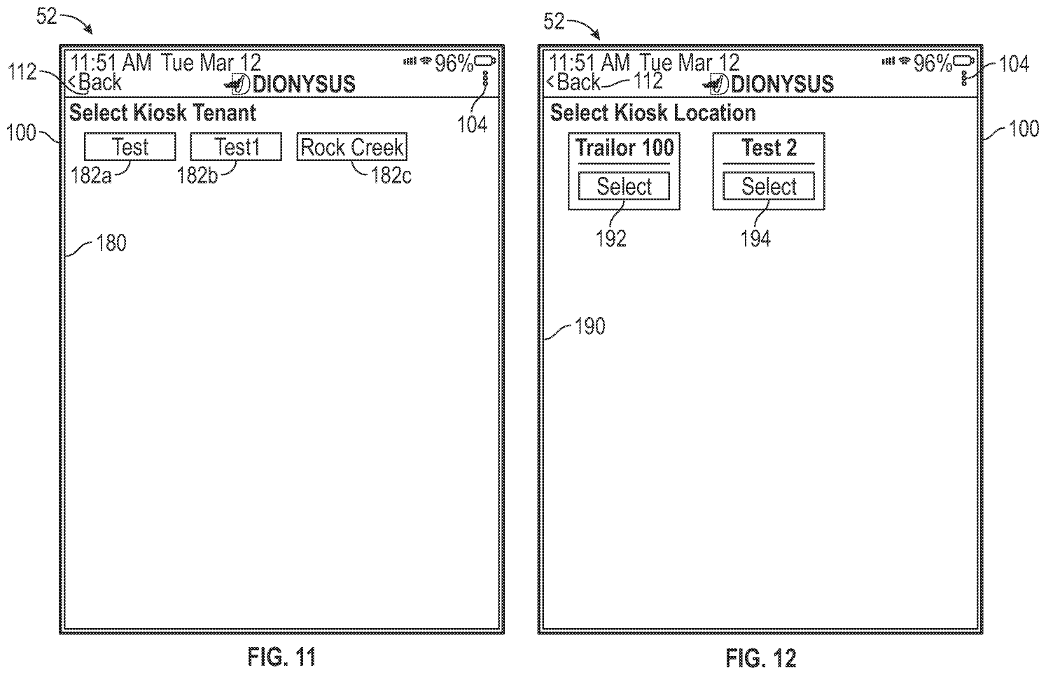

Referring now to FIG. 11, the application 52 is provided with a kiosk tenant page 180. The kiosk tenant page 180 allows the user to select a kiosk tenant in which the kiosk terminal 13 will be placed using tenant selection buttons 182a-182c. it should be noted that any number of kiosk tenants may be listed on the kiosk tenant page and have an associated tenant selection button 182.

Referring now to FIG. 12, the application 52 is provided with a kiosk location page 190. The kiosk location page 190 is provided with location selection buttons 192 and 194. The location selection buttons 192 and 194 may be programmed with an associated location such that selection of the location selection button 192 or 194 inputs the associated selection into the application 52. It should be noted that any number of locations may be available on the location page 190 with each having an associated location selection button. By way of illustration only, exemplary locations may be a restaurant, a bar, a sports venue, a music venue, and the like. It should further be noted that each location may have an associated set of rules programmed in the application 52. For instance, a sports venue may have a four-beverage maximum on a given night. In such an instance, the application 52 may be programmed to limit the number or type of beverages a user may purchase based on the rules for the venue. Further, the rules for each venue may be varied depending on type of event, day of the week, or time of day, for instance. Thus, the application 52 allows beverage distribution to be controlled as needed.

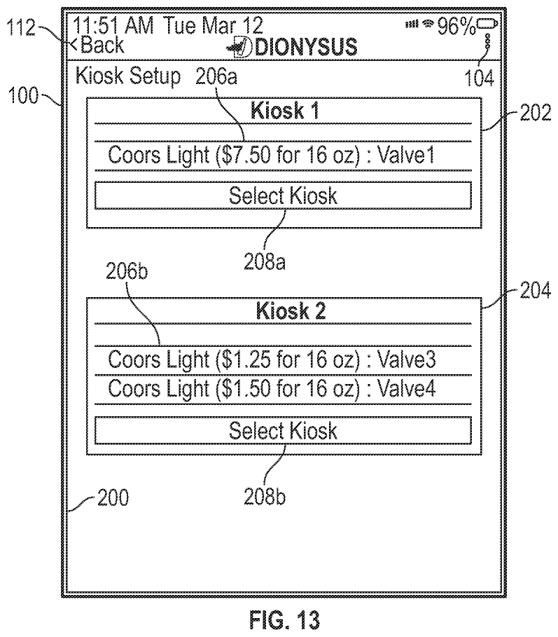

Referring now to FIG. 13, the application 52 is provided with a kiosk set up page 200. The kiosk setup page 200 is provided with kiosk sections 202 and 204 which display information about different kiosks. In the illustrated embodiment, kiosk section 202 displays information about kiosk number one and kiosk section 204 displays information about kiosk number two. Kiosk sections 202 and 204 are provided with product information sections 206a and 206b and selection buttons 208a and 208b.

The product information sections 206a and 206b display information about products available at the associated kiosk. For instance, in the illustrated embodiment kiosk one has one product available and kiosk two has two products available. It should be noted that any number of products can be displayed in the product information sections 206a and 206b of the kiosk sections 202 and 204.

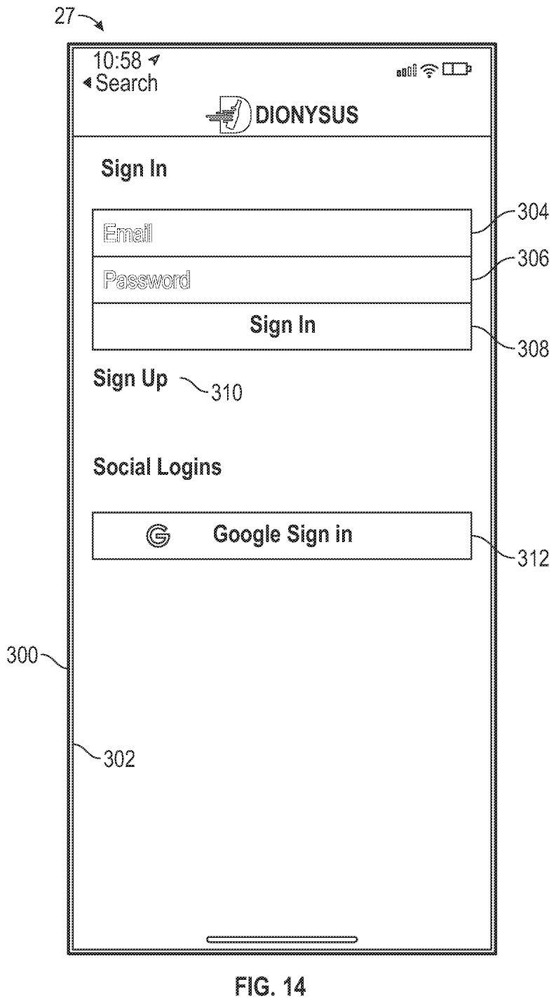

Referring now to FIG. 14, a user interface 300 of application 27 running on an exemplary user device 14 is illustrated. In FIG. 14, a sign in page 302 is illustrated having a username field 304, a password field 306, a sign in button 308, a sign-up button 310, and an alternate sign in button 312.

The username field 304 and the password field 306 of sign in page 302 are programmed to accept input from a user using input device 18 of the user device 14 indicative of a username and a password, respectively. The username field 304 and the password field 306 are designed to be used by current users of the application 27. Once the user enters their username and password into the username field 304 and the password field 306, respectively, the user may select the sign in button 308 to access the application 27.

Alternatively, the user may choose to sign in using the alternate sign in button 312 which may access user information from other applications such as Google®, Facebook®, Twitter®, and the like, for instance.

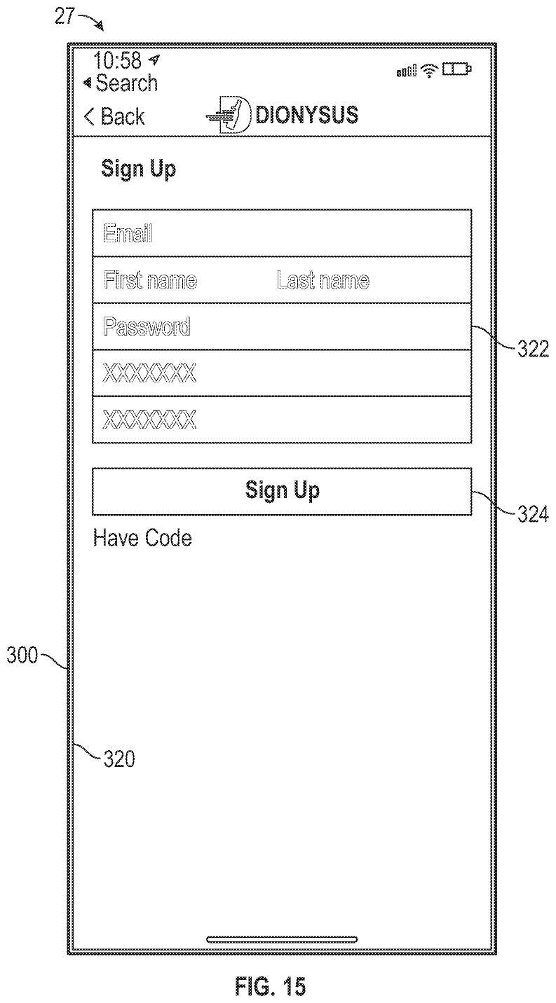

If the user is not yet signed up to use the application 27, the user may select the sign-up button 310 and enter the necessary information to gain access to the application 27. Selecting the sign-up button 310 in the application 27 may take the user to a sign-up page 320 as illustrated in FIG. 15. The sign-up page 320 may be provided with a personal information section 322 and a sign-up button 324. The personal information section 322 may contain a plurality of fields designed to accept input from the user indicative of personal information such as name, address, phone number, age, and password, for instance. Once the user has input the information into the personal information section 322 the user may indicate their finish by selecting the sign-up button 324 which causes the application 27 to send the personal information input into the personal information section 322 over the network 16 to the host system 12 where it is stored in the database 32. Alternatively, if a connection to the network 16 is not available at the time the application 27 may be programmed to store the personal information in memory 26 of the user device 14 until a connection to the network 16 is established.

It should be noted that the application 27 may be programmed to accept input of the information indicative of a government identification such as a driver's license. Such input may include capturing an image of the government identification for storage in the application 27 and/or on the host system 12. In this way, the application 27 is able to verify the age and identification of the user for use in purchasing products that may be subject to age restrictions, e.g., beverages containing alcohol. Further, the application 27 may be programmed with facial recognition capability that allows the application 27 to compare a picture on the government identification to an image captured in real time of the user to verify that the user of the application 27 is indeed the person represented in the government identification. When the application 27 uses facial recognition to match the user with an image on their government identification, for instance, the application 27 may be programmed to require a certain level of match confidence before allowing the user to purchase restricted products. For instance, the application 27 may be programmed to require a match confidence of between 80% and 99%. The match confidence level may be determined by a licensing agency, for instance, for the jurisdiction in which the application 27 is running in which case the match confidence may be set at whatever level is required. If the match confidence is lower than required, the application 27 may be programmed to send an alert requiring authorization from a human operator, such as a bar tender, to verify the user's identity. In such a case, the application 27 may be programmed to accept input from the human operator indicating that the user has been positively identified and is authorized to purchase restricted products.

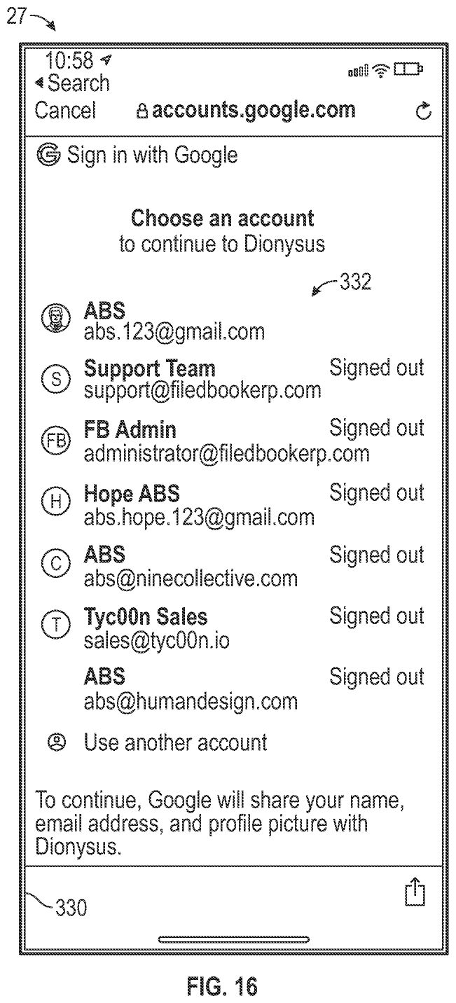

Referring now to FIG. 16, the application 27 may connect to other applications to capture personal information associated with the user. For instance, the application 27 may be provided with an alternate identification page 330 displayed in the user interface 300 that includes user identifications in a user identification field 332. The user identifications in the user identification field 322 may be selectable such that the information associated with the user identifications displayed in the user identification field 332 may be captured from the other applications and imported into the application 27.

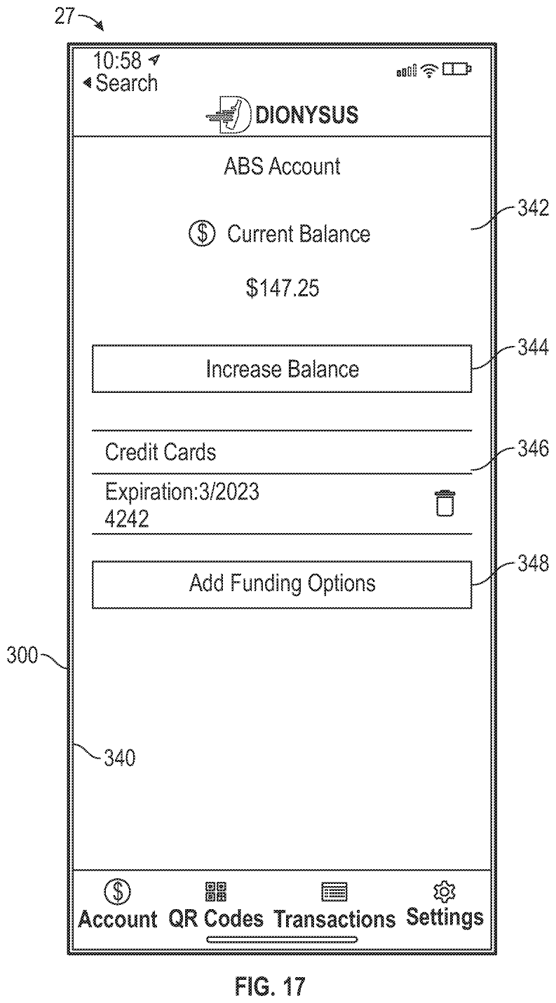

Referring now to FIG. 17, the application 27 may be provided with a balance page 340. The current balance page 340 may be provided with a balance section 342, an increased balance button 344, a funding options information section 346, and an add funding options button 348.

The current balance section 342 of the balance page 340 displays the available amount of money to make purchases using the application 27. If the user wishes to increase the balance available to make purchases the user may select the increase balance button 344 on the balance page 340. The user may add funds to the application 27 using credit cards, debit cards, bank accounts, credits distributed by a venue, and the like. For instance, when using the application 27 at a restaurant having a kiosk set up to dispense pressurized fluid, the user must have monetary funds available to purchase beverages. Monetary funds may be added using any of the funding options listed above. Alternatively, a venue such as a music festival or sporting events may choose to issue credits to be used during the event. In such a case, monetary value as well as number of credits would be displayed in the current balance section 342 of the application 27.

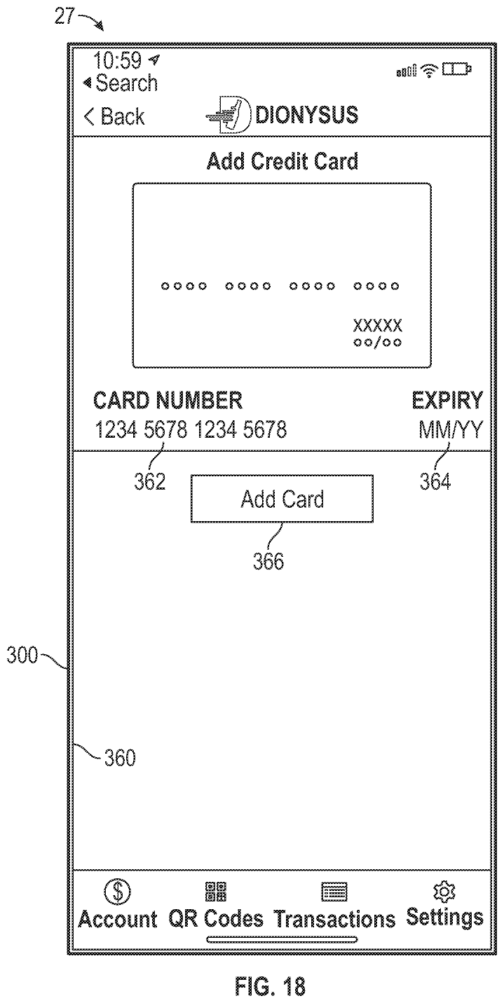

The funding options information section 346 of the application 27 may display all of the funding options available for use by the user. If the user wishes to add another funding option the user may select the add funding options button 348 and input the necessary information into the application 27 to make a new funding option available. For instance, FIG. 18 illustrates an add a credit card page 360 which allows the user to input a card number into input section 362 and the expiration date of the credit card in input section 364 before selecting the add card button 366 which causes the input information to be saved in the memory 26 of the user device 14, and/or to be transmitted from the application 27 over the network 16 to the host system 12 to be stored in the database 32.

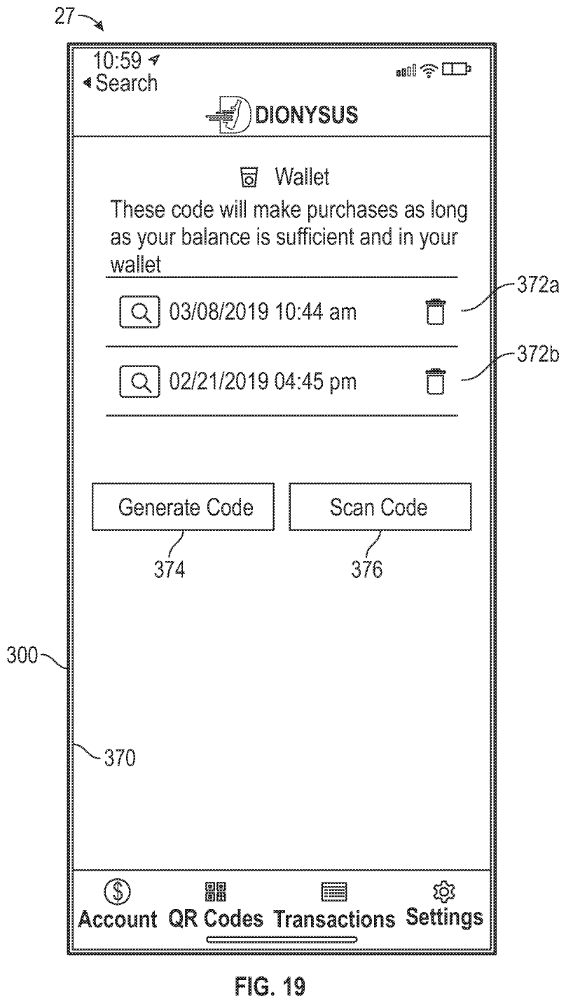

Once funds have been added in the application 27 the user may generate a code for use in making purchases on a wallet page 370 illustrated in FIG. 19. The wallet page 370 is provided with generated code sections 372a and 372b, a generate code button 374, and a scan code 376. It should be noted that application 27 may allow the user to generate any number of codes which will be displayed on the wallet page 370 for selection and future use as will be described further herein. The generated codes may be programmed to expire after a predetermined time, only work within a limited geographic area, or at a specific venue, for instance.

If the user wishes to generate a new code the user may select the generate code button 374. If the user wishes to scan an existing code, the user may select the generated code section 372a or 372b associated with the desired code then select the scan code button 376.

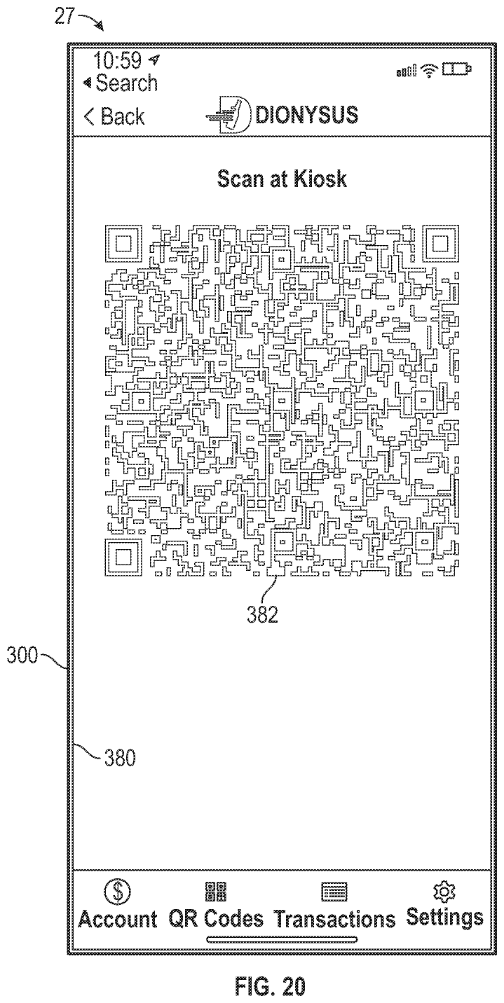

Once the user selects the generate code button 374 or an existing code and the scan code button 376, the application 27 is programmed to display a code page 380 with a code 382 as illustrated in FIG. 20. In the embodiment illustrated in FIG. 20, a code 382 is a QR code, however, it should be noted that the code 382 may be any scannable code known in the art. Display of the code 382 allows the user to scan the code at the kiosk 4 using the code reader 110 on the scan page 108 of the application 52 on the kiosk terminal 13 to purchase, for instance, a beverage.

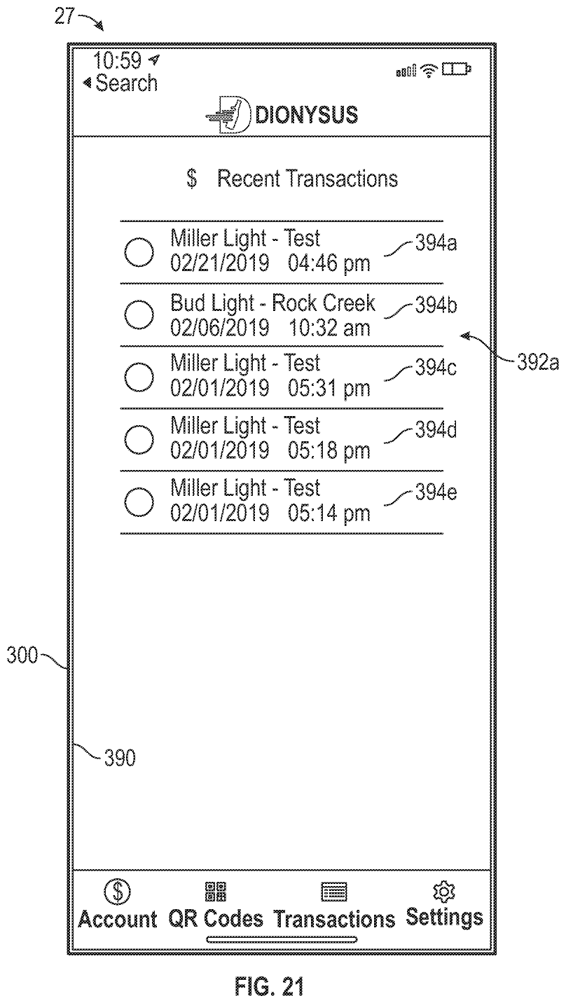

Referring now to FIG. 21, the application 27 is provided with a recent transactions page 390. The recent transactions page 390 includes a recent transaction section 392 which displays recently purchased items 394a-394e.

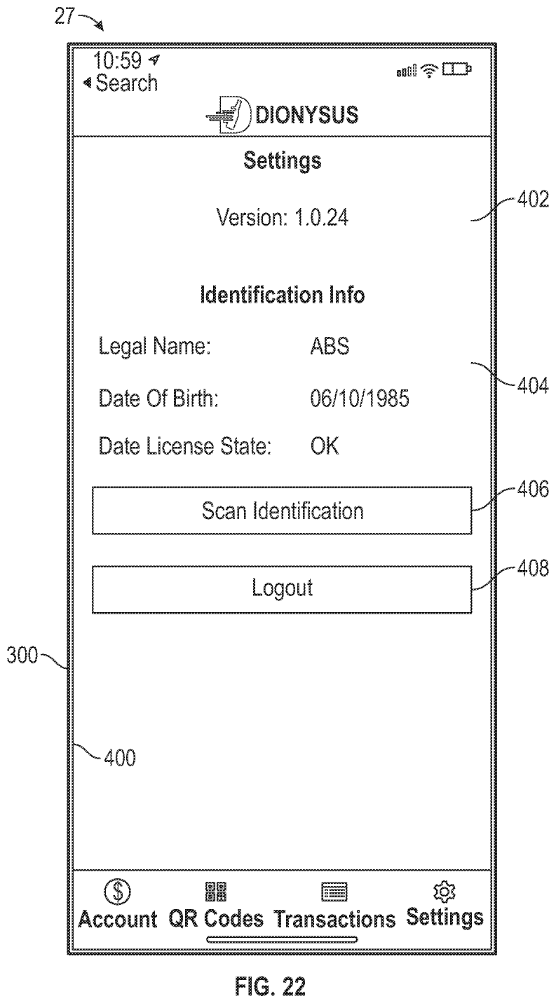

Referring now to FIG. 22, the application 27 is provided with an identification page 400. The identification page 400 is provided with a version section 402, an identification info section 404, a scan identification button 406, and a logout button 408.

To verify the identification information included in the identification info section 404, the scan identification button 406 of the application 27 may be programmed to activate the camera 21 of the user device 14 to capture an image of the user's government identification. For instance, the user may capture an image of their driver's license to verify their identification. In such an embodiment, the application 27 may be programmed to identify text in the government identification and match that text with user information contained in the identification info section 404 of the application 27. In this way, the application 27 may verify personal information such as name, date of birth, and driver's license state as displayed in FIG. 22.

In some embodiments, the application 27 may be programmed to capture an image of the front of the user's government identification and an image of the back of the user's government identification and compare the information to ensure that they match. For instance, the application 27 may extract text from the front of the government identification using optical character recognition (OCR) and compare information such as name and birthdate to the information contained in a barcode on the back of the government identification to verify that they match. In some embodiments, the application 27 may be programmed to compare the barcode on the back of the user's government identification to a structure prescribed by an issuing authority of the user's government identification to ensure that the user's government identification is legitimate.

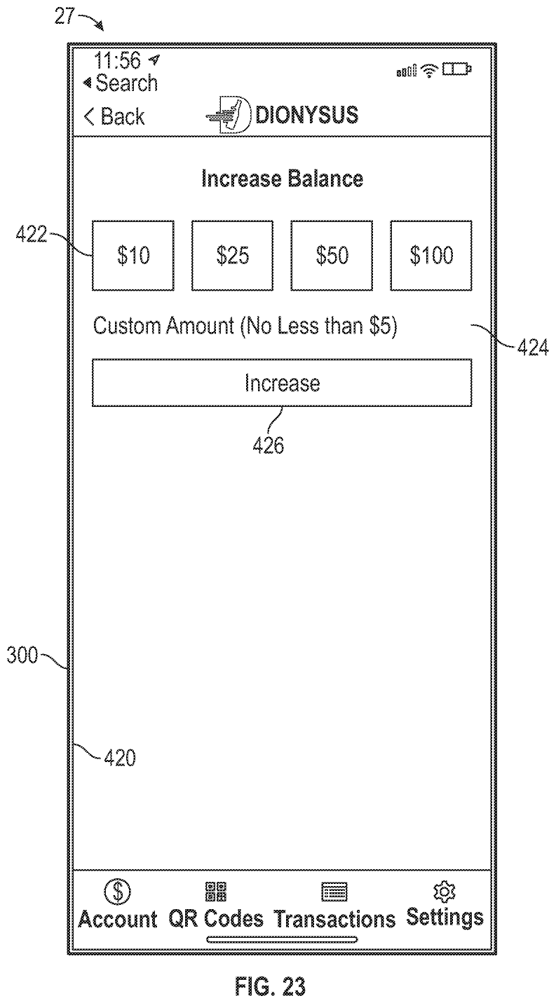

Referring now to FIG. 23, the application 27 is provided with an increase balance page 420. The increase balance page 420 is provided with monetary value buttons for 22 (only one of which is numbered in the drawings), and input section 424 and an increase button 426. The monetary value buttons 22 are programmed with specific monetary values associated with each button. If the user desires to increase their balance by a monetary value associated with one of the monetary value buttons 22 the user may select the desired monetary value then select the increase button 426. If the user wishes to input a value themselves, the user may input the value in the input section 424 then select the increase button 426 to increase their balance. It should be noted, that wall the exemplary embodiments have illustrated monetary value inputs credit or token values could also be entered in the application 27 as may be desired by some venues as described above.

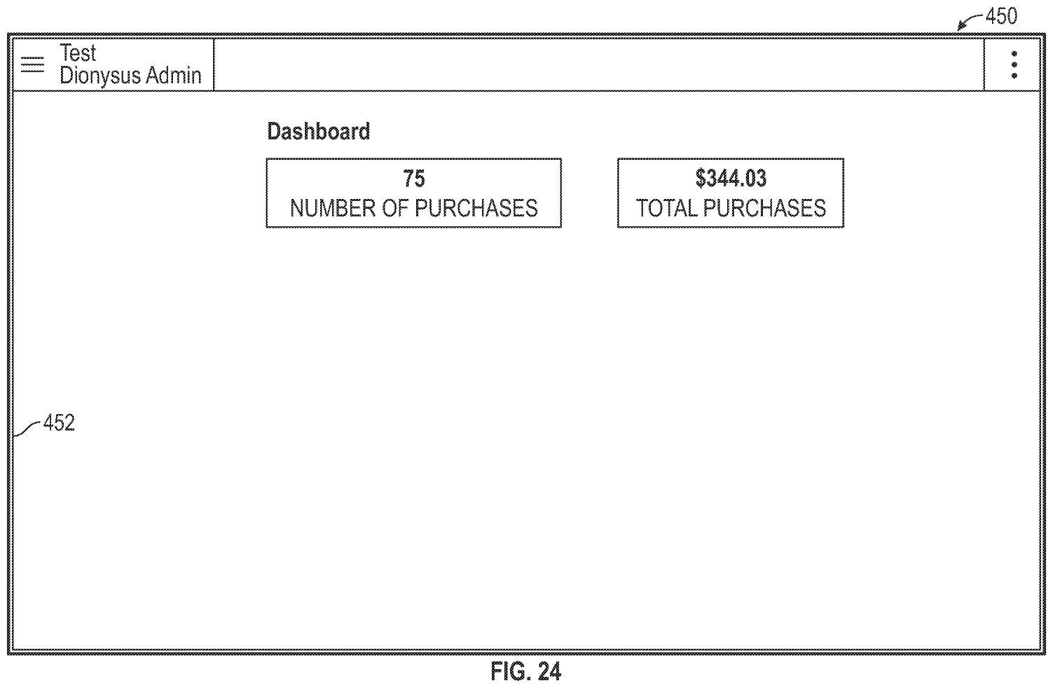

Referring now to FIG. 24, a tenant portal 450 is shown as may be displayed in a web browser of external system 17, for instance. Tenant portal 450 allows the user to remotely add locations, items for sale, kiosk information, and valves set up as well as reporting and company information. The tenant portal 450 may be displayed as a series of user interfaces such as dashboard 452. Dashboard 452 may include reporting information such as number of purchases and total of purchases as shown in FIG. 24. It should be noted that the exemplary reporting information in FIG. 24 is provided for illustration purposes only and should not be considered limiting.

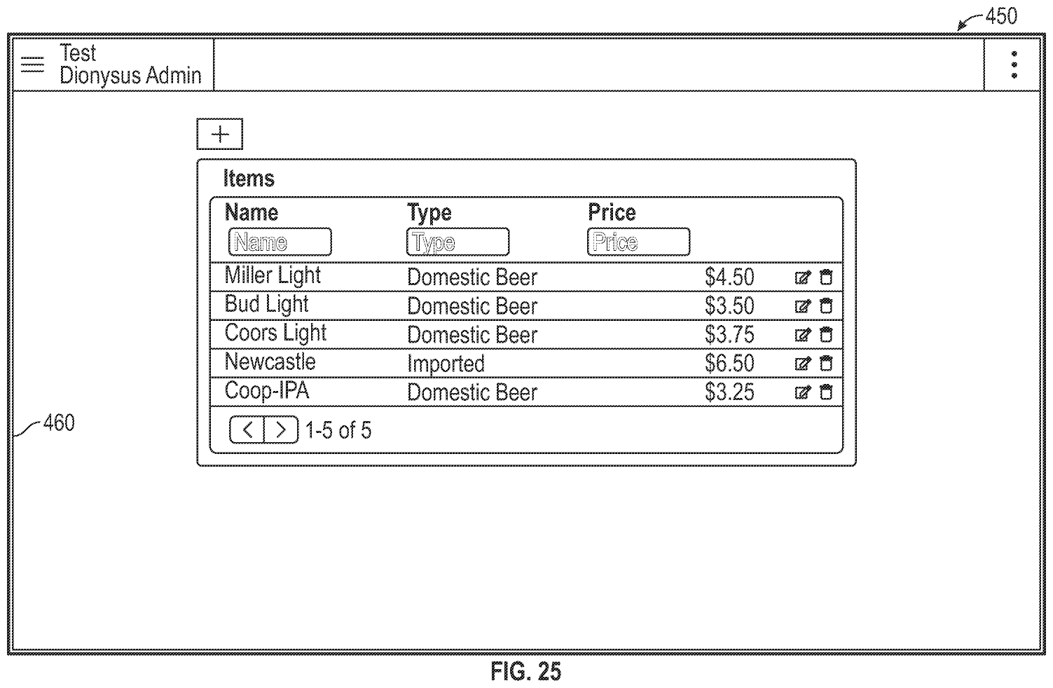

Referring now to FIG. 25, the tenant portal 450 may be provided with an items may include, for instance, name, type, and price. Using the items page 460, the user may be able to remotely administer the items available, their name, their type, and the price per item or unit.

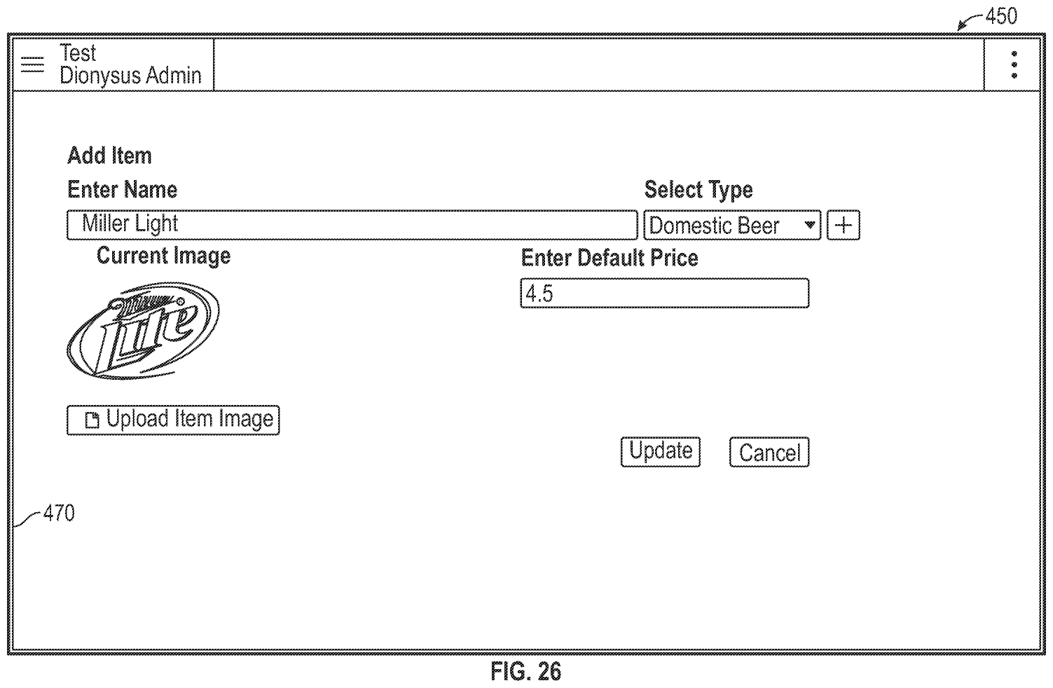

Referring now to FIG. 26, the tenant portal 450 may be provided with an add item page 470. The add item page 470 allows a user to remotely add and/or update an item. As illustrated in FIG. 25, the user may upload an image associated with the item, enter a default price, enter a name for the item, and select a type for the item.

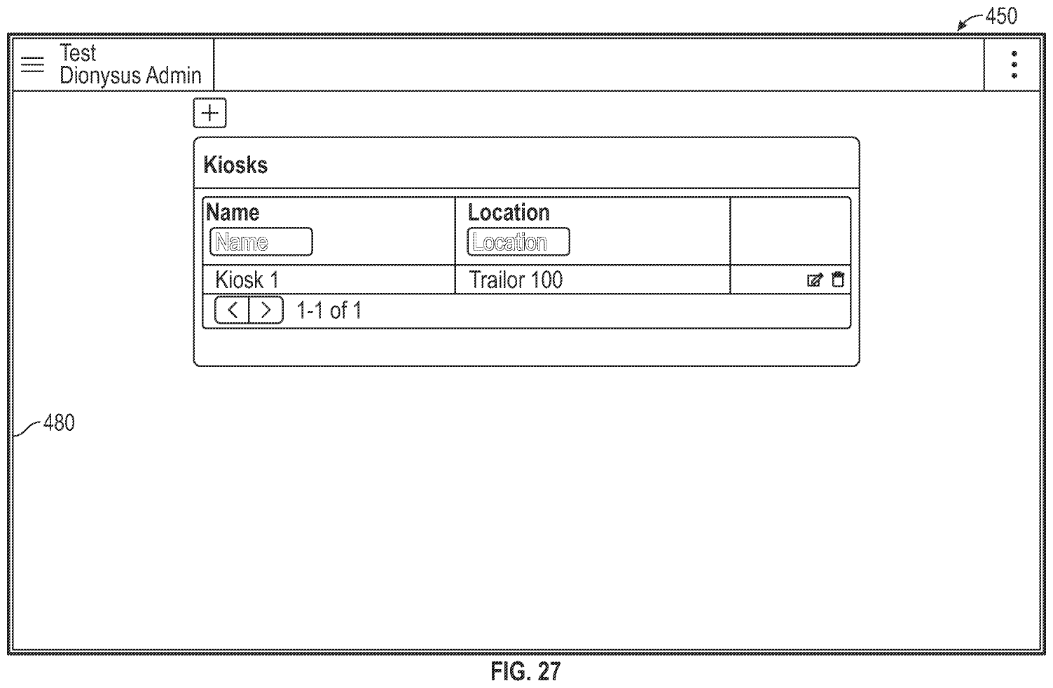

Referring now to FIG. 27, the tenant portal 450 may be provided with a kiosks page 480. The kiosks page 480 may provide information such as the name of the kiosk, location of the kiosk, and the ability to delete kiosks.

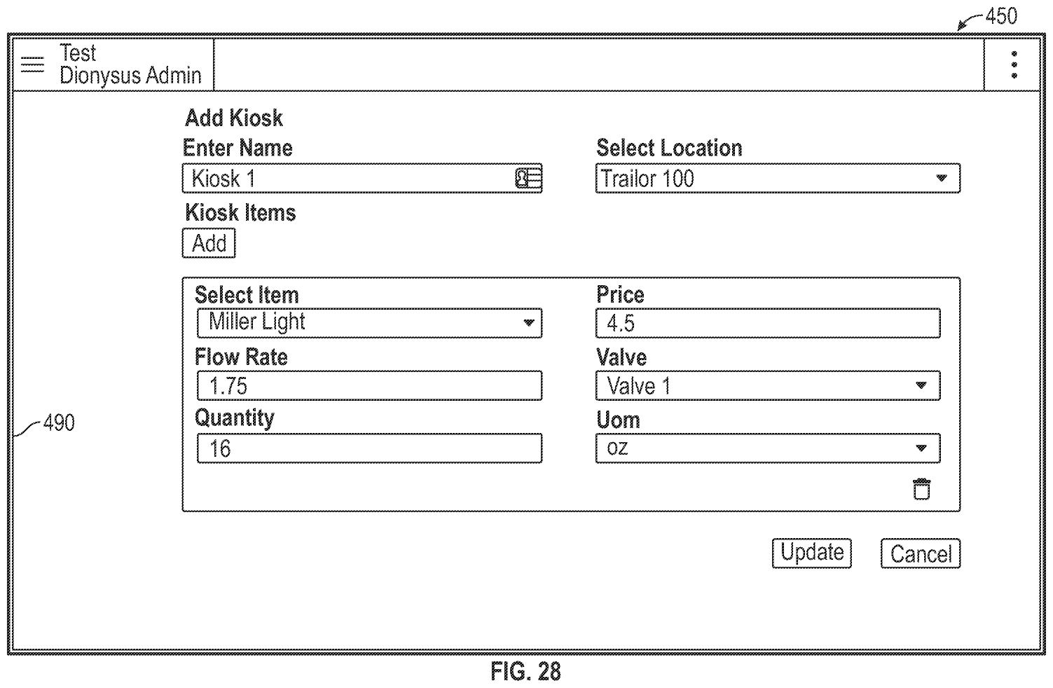

Referring now to FIG. 28, the tenant portal 450 may be provided with an add kiosks page 490 which is programmed to the allow the user to add a new kiosk and/or update information on an existing kiosk.

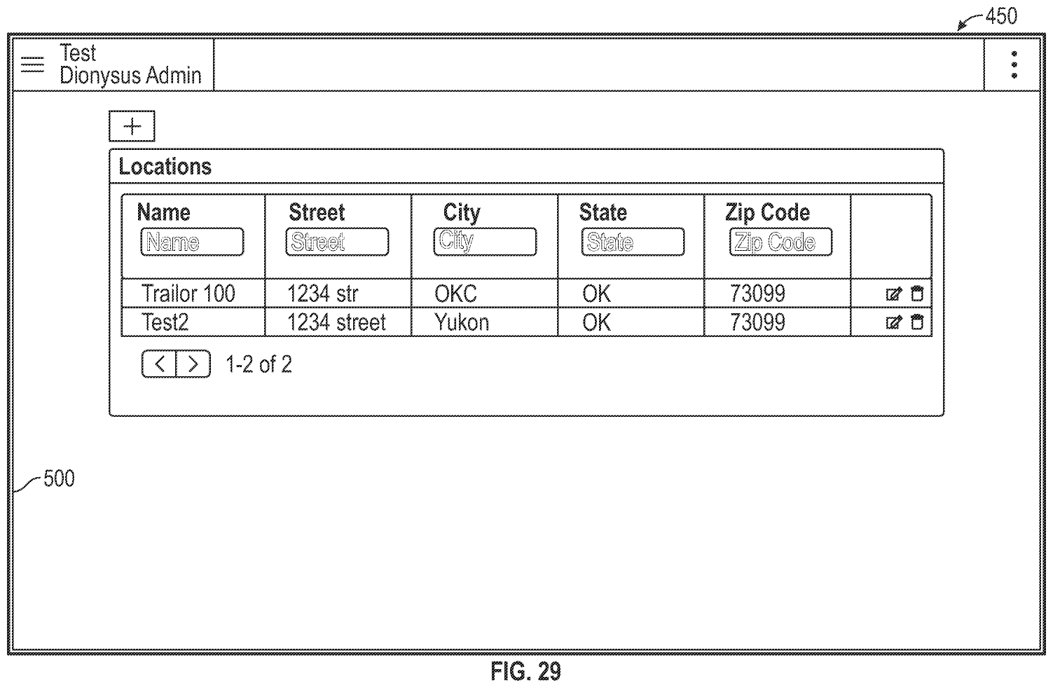

Referring now to FIG. 29, the tenant portal 450 may be provided with a locations page 500 which provides information on existing locations and allows the user to delete locations if desired. The information on existing locations may include the name of the location, street, city, state, and ZIP Code.

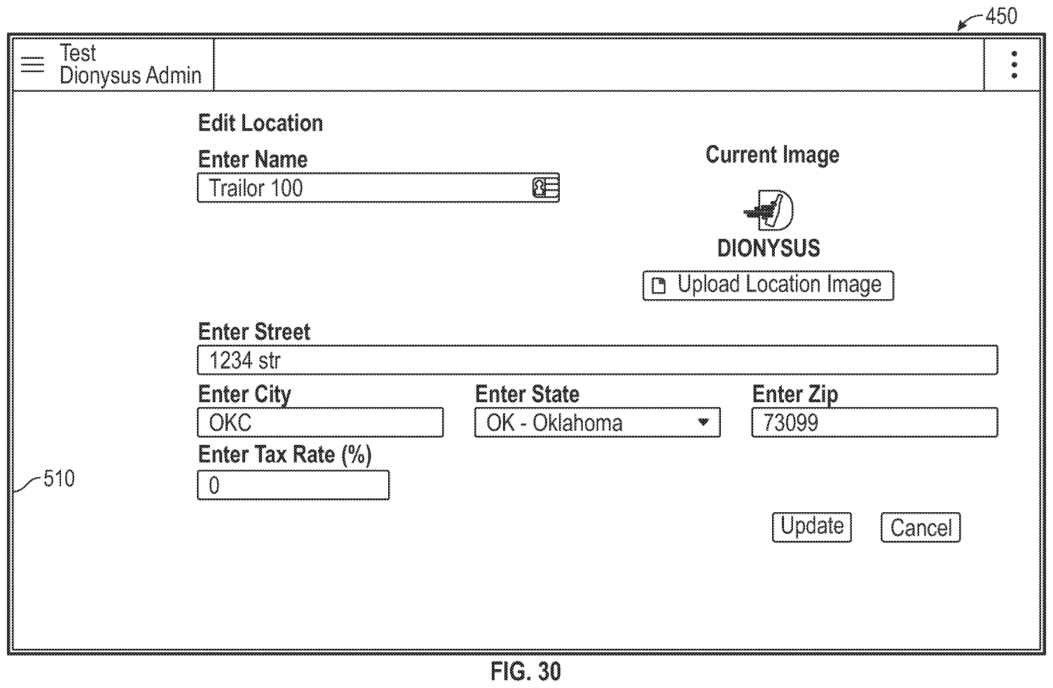

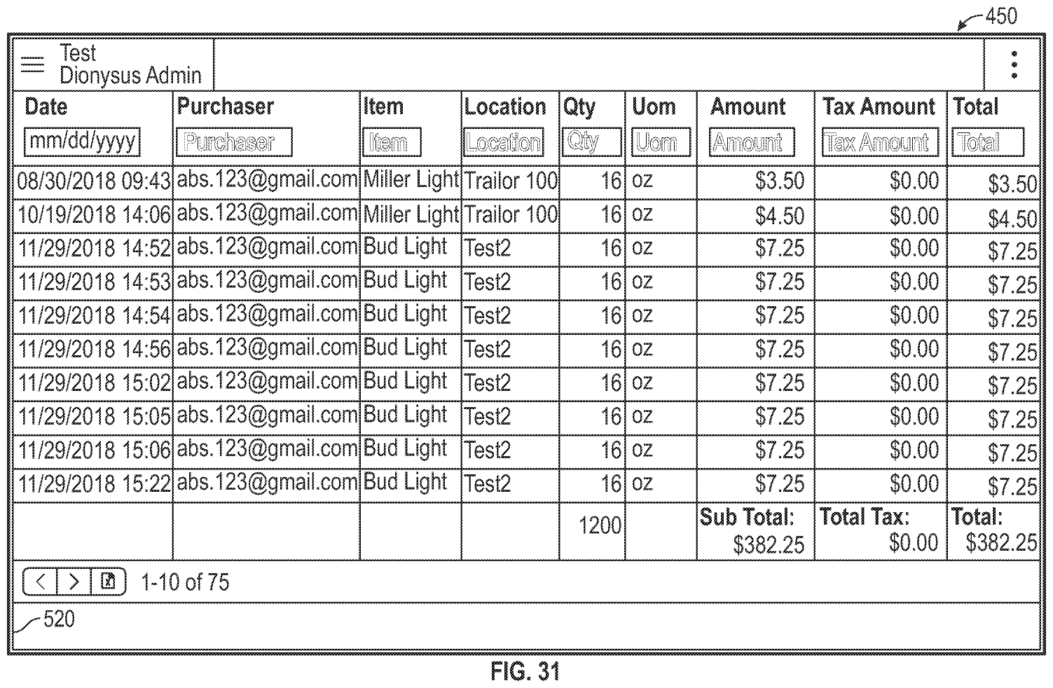

Referring now to FIG. 30, the tenant portal 450 may be provided with an edit location page 510. The edit location page 510 allows a user to edit location information associated with the selected location. Location information may include name, street, city, state, ZIP Code, tax rate, and an image associated with the location.

Referring now to FIG. 31, the tenant portal 450 may be provided with a purchase information page 520. The purchase information page 520 may include information such as a date, a purchaser, an item, a location, a quantity, an amount, a tax amount, and a total amount for a given set of transactions. The given set of transactions may be selected by the user and may be, for instance, transactions by location, by item, by purchaser, by date, by type, and the like. In other words, the purchase information page 520 allows the user to organize purchase information as needed and/or desired.

As used herein, the term kiosk may refer to a location such as a restaurant or bar, or, kiosk may return refer to a section within a location such as a restaurant or bar. For instance, a table at a restaurant may be a kiosk. In such an instance, a kiosk terminal 13 would be located at the table and allow the user to purchase a desired beverage or beverages and the beverage or beverages would be dispensed from a solenoid valve 2 located at the table. It should be noted, that the restaurant may have a kiosk at each table with each kiosk having all of the elements described herein.

It should be noted that transactions have been described herein using a code, such as a QR code, to initiate a transaction. However, it should be noted that it is contemplated that other means of communication between the user device in kiosk terminal are contemplated. For instance, the user device 14 may include an RFID transmitter in the kiosk terminal 13 may include an RFID reader whereby the user device 14 may communicate information to the kiosk terminal 13 using radio frequencies. In such an embodiment, purchaser information would be transmitted from the user device 14 to the kiosk terminal using RFID. It is further contemplated that other methods of short-range wireless communication such as Bluetooth® may be used.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. A method of controlling fluid distribution, comprising:
establishing communication between at least one kiosk having a first processor, a first input device, a first output device, a first communication device, and non-transitory computer readable memory storing a first set of instructions and a first database, and at least one user device having a second processor, a second input device, a second output device, a second communication device, a camera, and non-transitory computer readable memory storing a second set of instructions and a second database;
executing the second set of instructions that, when executed, cause the user device to accept input from a user of the user device indicative of user information and store the user information in the second database;
upon storing the user information, the second set of instructions causes the user device to provide a selectable indicator on the second output device, responsive to the user selecting the indicator, the second set of instructions causes the user device to capture an image of a form of identification of the user using the camera, the image of the form of identification including a likeness of the user;
responsive to capturing the image of the form of identification of the user, the second set of instructions causes the user device to identify text in the image of the form of identification of the user and match that text with the user information in the second database, and provide a selectable indicator on the second output device;
responsive to the user selecting the selectable indicator, the second set of instructions causes the user device to capture a real-time image of the user;
responsive to capturing the real-time image of the user, the second set of instructions causes the user device to compare the real-time image of the user with the likeness of the user in the image of the form of identification of the user stored in the second database to ensure that they match;
responsive to matching the user information with the text of the form of identification and the real-time image of the user with the likeness of the user in the image of the form of identification, the second set of instructions causes the user device to generate a code for communication to the at least one kiosk using the second communication device;
responsive to the first communication device of the at least one kiosk communicating with the second communication device of the user device and receiving the code, the first set of instructions cause the at least one kiosk to accept input from the user indicative of a selection of a type and a number of units of fluid;
responsive to receiving the selection of the type and number of units of fluid, the first set of instructions cause the at least one kiosk to dispense the type and number of units of fluid and store the type and number of units of fluid in the first database associated with the user.

2. (canceled)

3. The method of controlling fluid distribution of claim 1, wherein the code is a QR code which is displayed on the output device of the user device and the at least one kiosk is provided with a code reader that scans the QR code displayed on the output device of the user device.

4. The method of controlling fluid distribution of claim 1, wherein the second communication device of the user device includes a radio frequency identification (RFID) transmitter and the first communication device of the at least one kiosk includes an RFID reader and the code is communicated via radio frequency.

5. The method of controlling fluid distribution of claim 1, wherein responsive to matching the user information with the text of the form of identification and the real-time image of the user with the likeness of the user in the image of the form of identification, the second set of instructions causes the user device to generate a wallet page and the wallet page is provided with a selectable indicator, responsive to the user selecting the indicator on the wallet page, the second set of instructions causes the user device to generate the code for communication to the at least one kiosk.

6. The method of controlling fluid distribution of claim 5, wherein the code expires after a predetermined amount of time.

7. The method of controlling fluid distribution of claim 1, wherein the user device is further provided with a device locator and the code is programmed to only work within a predetermined geographic area and the method further comprises, responsive to the first communication device of the at least one kiosk communicating with the second communication device of the user device, the second set of instructions causes the user device to determine a current location of the user device using the device locator and determine if the user device is within the predetermined geographic area prior to communicating the code to the at least one kiosk.

8. A machine for controlling the distribution of a fluid, comprising a user-operated device having configurable instructions for the control of the distribution of a fluid, the configurable instructions consisting of:
establishing communication between at least one kiosk having a first processor, a first input device, a first output device, a first communication device, and non-transitory computer readable memory storing a first set of instructions and a first database, and at least one user device having a second processor, a second input device, a second output device, a second communication device, a camera, and non-transitory computer readable memory storing a second set of instructions and a second database;
executing the second set of instructions that, when executed, cause the user device to accept input from a user of the user device indicative of user information and store the user information in the second database;
upon storing the user information, the second set of instructions causes the user device to provide a selectable indicator on the second output device, responsive to the user selecting the indicator, the second set of instructions causes the user device to capture an image of a form of identification of the user using the camera;
responsive to capturing the image of the form of identification of the user, the second set of instructions causes the user device to identify text in the image of the form of identification of the user and match that text with the user information in the second database;
responsive to matching the user information with the text of the form of identification, the second set of instructions causes the user device to generate a code for communication to the at least one kiosk using the second communication device;
responsive to the first communication device of the at least one kiosk communicating with the second communication device of the user device and receiving the code, the first set of instructions cause the kiosk to accept input from the user indicative of a selection of a type and a number of units of fluid;
responsive to receiving the selection of the type and number of units of fluid, the first set of instructions cause the at least one kiosk to dispense the type and number of units of fluid and store the type and number of units of fluid in the first database associated with the user.
